(19) United States
(12) Patent Application Publication
(10) Pub. No.: US 2014/0087168 A1
(43) Pub. Date: Mar. 27, 2014

(54) ARTICLES COMPRISING A WEATHER-RESISTANT ADHESIVE LAYER IN CONTACT WITH A LOW SURFACE-ENERGY MATERIAL

(71) Applicant: E I DU PONT DE NEMOURS AND COMPANY, Wilmington, DE (US)

(72) Inventor: CHEN QIAN ZHAO, Newark, DE (US)

(21) Appl. No.: 13/930,381

(22) Filed: Jun. 28, 2013

Related U.S. Application Data
(60) Provisional application No. 61/665,946, filed on Sep. 25, 2012.

(51) Int. Cl. B32B 27/08; B32B 27/28; B32B 15/04; B32B 27/32; B32B 27/12

(52) U.S. Cl. CPC B32B 27/08; B32B 27/322; B32B 27/12; B32B 15/043; B32B 27/283
USPC 428/221; 428/421; 428/422

(57) ABSTRACT

One aspect of the invention is a laminate article including a first substrate layer comprising a fluorine-containing surface, a second substrate layer and an adhesive layer in contact with both the fluorine-containing surface of the first substrate layer and the second substrate layer. The adhesive layer includes a polydimethylsiloxane resin and a peroxide.

### FIELD OF THE INVENTION

This invention relates to laminate articles comprising an adhesive layer, containing a siloxane, that is weather-resistant and has good adhesion to low surface energy materials.

### BACKGROUND

Fluorine-containing materials such as polytetrafluoroethylene, polyvinylidene fluoride (PVDF), and terpolymers of tetrafluoroethylene, hexafluoropropylene and vinylidene fluoride have excellent chemical and physical inertness, as well as excellent barrier properties and hydrophobic characteristics. As a result, such materials have excellent weatherability and high thermal stability. However, fluorine-containing materials are is expensive and it would often be desirable to use them in combination with other materials, e.g., in laminates, to reduce costs. But fluorine-containing materials inherently have low surface energy and suffer from poor adhesion to dissimilar materials, making it difficult to form laminates. To overcome this problem, various methods for improving the adhesion properties of fluorine-containing materials have been investigated.

One approach is to modify the fluorine-containing material itself to enable its adhesion to an existing hydrocarbon material (e.g., an adhesive) via a wet or dry surface treatment of the fluorine-containing material. Alternatively, the fluoropolymer can be modified, for example, by creating a polymer blend or by dehydrofluorination.

Other efforts have focussed on developing adhesives that adhere well to fluorine-containing materials. U.S. Pat. No. 5,079,047 proposes a solventless, photoinitiated adhesive comprising, by weight, 60-95% of an alkyl acrylate, 5-40% of a copolymerizable monomer such as acrylic acid, and 10-30% ethylene vinyl acetate. U.S. Pat. No. 3,737,483 proposes a carboxylated polymer product comprising maleic anhydride polymerized with an alpha-olefin in contact with an ethylene vinyl acetate (EVA) copolymer in the presence of an organic peroxide and organic diluent. U.S. Pat. No. 3,749,756 proposes the same carboxylated polymer product without the peroxide and organic diluent. U.S. Pat. No. 4,347,341 proposes ethylene graft copolymers containing anhydride or carboxyl groups which are made from vinyl esters of monocarboxylic acid, maleic anhydride and esters thereof which are radically polymerized in the presence of 30-95% by weight of ethylene homopolymers or ethylene vinyl ester copolymers. U.S. Pat. No. 4,762,882 proposes modified polyolefin resins which consist essentially of a copolymer of ethylene and alpha-olefin and an unsaturated carboxylic acid grafted on the ethylene copolymer. U.S. Pat. No. 4,810,755 proposes an adhesive composition comprising a metal-containing composition consisting of an ethylene-(meth)acrylate copolymer grafted with an ethylenic unsaturated carboxylic acid or its acid anhydride and an ethylenic unsaturated carboxylic or its acid anhydride of a metal hydroxide. U.S. Pat. No. 4,908,411 proposes is modified ethylenic random copolymers derived from ethylene alpha-olefin copolymers grafted with unsaturated carboxylic acids, styrene-type hydrocarbons, or unsaturated silanes. U.S. Pat. No. 4,917,734 proposes ethylene copolymers which have been grafted with styrene-based, vinyl, acrylic, and/or methacrylic grafting monomers. U.S. Pat. No. 4,977,212 proposes resin compositions comprising a metal-containing composition consisting of an ethylene ester copolymer and an unsaturated carboxylic acid or its acid anhydride, a saponified EVA copolymer, and a hydrophobic thermoplastic resin.

U.S. Pat. No. 6,441,114 discloses the use of amide-containing adhesives with substrates derived from hydrofluorinated monomers.

U.S. Pat. No. 7,767,752 discloses acrylic pressure-sensitive adhesives comprising an acrylic polymer, an ester plasticizer, an alkali metal salt, and a multifunctional cross-linking agent such as an isocyanate, epoxy, aziridine or metal chelate cross-linking agent.

Despite such proposals, there is still a need for adhesives that possess enhanced adhesion to low surface energy substrates such as fluorine-containing polymer substrates. There is also a need for laminated articles comprising fluorine-containing polymer substrates that are weather-resistant.

### SUMMARY

One aspect of the invention is a laminate article including a first substrate layer comprising a fluorine-containing surface, a second substrate layer and an adhesive layer in contact with both the fluorine-containing surface of the first substrate layer and the second substrate layer. The adhesive layer includes a polydimethylsiloxane resin and a peroxide.

### BRIEF DESCRIPTION OF THE FIGURE

FIG. 1 depicts a multilayer structure comprising an FEP layer 1, an adhesive layer 2 comprising a polydimethylsiloxane resin and a peroxide, and a PET layer 4 coated on both sides with an atomic layer deposition coating of alumina 3.

### DETAILED DESCRIPTION

One aspect of the invention is a laminate article comprising:

a) a first substrate layer comprising a fluorine-containing surface;
b) a second substrate layer; and
c) an adhesive layer in contact with both the fluorine-containing surface of the first substrate layer and the second substrate layer, wherein the adhesive layer comprises:

i) a polydimethylsiloxane resin; and

ii) a peroxide.

Suitable first substrate layers include fluoropolymer films, fluoropolymer sheets and fluoropolymer-coated substrates. Suitable fluoropolymers include polytetrafluoroethylene (PTFE), polyvinyl fluoride (PVF), polyvinylidene fluoride (PVDF), fluorinated ethylene-propylene (FEP) copolymer, and polyethylenetetrafluoroethylene (ETFE).

Suitable second substrate layers include foamed sheets, metal sheets, fabric, polymer films and polymer sheets. Suitable polymer films and sheets include those comprising polyolefins (e.g., polyethylene or polypropylene), polyamides (e.g., nylon-6, nylon-6,6, or nylon-6,12) polyimides and polyesters (e.g., polyethylene terephthalate, polyethylene naphthalate, or polytrimethylene terephthalate). The polymer films and sheets can be coated, for example with metals (e.g., aluminum), metal oxides (e.g., aluminum oxide or indium tin oxide), or metal nitrides (e.g., silicon nitride).

The adhesive layer can be applied to either the first or second substrate layers, or to both the first and second substrate layers, but typically is applied to the more robust of the two substrate layers. The adhesive layer, which comprises a mixture of a polydimethylsiloxane and a peroxide, can be applied to one or both sides of a substrate layer in a conventional manner, for example, by spraying, knife-coating, roller-coating, casting, drum-coating, or dipping. Indirect application using a transfer process with silicon release paper also can be used.

The adhesive layer can have any useful thickness. In some embodiments, the adhesive layer has a thickness of 25-75 micrometers, or 25-50 micrometers.

After the adhesive layer has been applied to the first and/or second substrate layer, the coated substrate layer can be dried at a temperature from 75-150° C. to remove solvent or other volatile materials.

The article can be formed by conventional laminate-forming techniques. For example, a first substrate layer comprising a fluorine-containing surface can be coated with a mixture comprising the polydimethylsiloxane adhesive and the peroxide, followed by drying. Then the second substrate layer can be placed in contact with the dried adhesive composition to form the laminate.

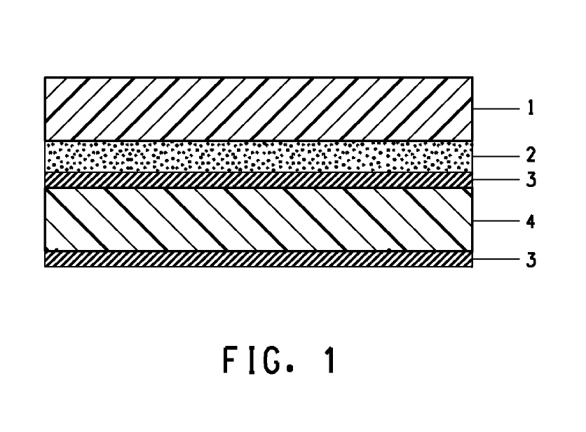

In one embodiment, as depicted in FIG. 1, a multilayer structure can comprise a fluorinated ethylene-propylene (FEP) copolymer layer 1, an adhesive layer 2 comprising a polydimethylsiloxane resin and a peroxide, and a polyethylene terephthalate (PET) layer 4 coated on both sides with an atomic layer deposition (ALD) coating of alumina 3. Polydimethylsiloxanes are polymeric organosilicon compounds with a nominal chemical formula of CH₃[Si(CH₃)₂O]ₙSi(CH₃)₃, where n is typically 500-100,000. The polydimethylsiloxane can comprise H— or vinyl end groups, and/or branch points within an otherwise linear chain structure.

Polydimethylsiloxanes are commercially available in multiple viscosities, ranging from a thin pourable liquid (where n is low) to a thick rubbery semi-solid (where n is high). Suitable polydimethylsiloxanes for use in this invention are typically of moderate viscosity (5,000-60,000 centipoise at 25° C.), and are sometimes referred to as “resins”. Suitable commercially available polydimethylsiloxanes include Dow Corning® 7358 (“DC7358,” polydimethylsiloxane resin), and Dow Corning® Q2-7735 (“DCQ27735,” polydimethylsiloxane resin), both from Dow Corning Co., Midland, Mich.

Polydimethylsiloxanes can also be synthesized from dimethyldichlorosilane or diacetoxydimethylsilane and water. Silane precursors such as methyltrichlorosilane can be used to introduce branches or cross-links in the polymer chain.

Peroxides are capable of cross-linking polydimethylsiloxanes via radical reactions. Suitable peroxides for the purposes of the present invention include hydrogen peroxide and hydroperoxides. Hydroperoxides are peroxides that differ from hydrogen peroxide in that one of the hydrogen atoms of hydrogen peroxide is replaced by an organic radical, that is wherein the hydrogen atom is replaced by a carbon, Si, Ge, Sn, or other atom. Organic peroxides, for the purposes of the present invention are hydroperoxides wherein one of the peroxide oxygens is bonded to carbon, and can include peroxy acids wherein the organic radical is an acyl group. Organic peroxides suitable for use herein include: benzoyl peroxide; t-butyl peroxybenzoate; and 2,4-dichlorobenzoyl peroxide, for example. Commercially available peroxides can be suitable for use herein.

The adhesive layer optionally comprises from about 25-75 wt % of an organic solvent in which the other components of the adhesive layer can be dissolved. Suitable solvents include alcohols (ethanol, propanol, isopropanol, butanol, methyl cellusolve, butyl cellusolve, and 4-hydroxy-4-methyl-2-pentanone); esters solvents such as ethyl acetate and butyl acetate; ketone solvents such as methyl ethyl ketone and cyclohexanone; and hydrocarbon solvents such as hexane, cyclohexane, heptane, benzene, xylene, and toluene.

The adhesive layer can also be tackified. Hydrogenated hydrocarbon resins are especially useful when long-term resistance to oxidation and ultraviolet light exposure is required. Suitable hydrogenated resins include: the Escorez 5000 series of hydrogenated cycloaliphatic resins from Exxon; hydrogenated C₉ and/or C₅ resins such as the Arkon® P series of resins by Arakawa Chemical; hydrogenated aromatic hydrocarbon resins such as Regalrez 1018, 1085 and the Regalite® R series of resins from Hercules Specialty Chemicals. Other useful resins include hydrogenated polyterpenes such as Clearon® P-105, P-115 and P-125 from the Yasuhara Yushi Kogyo Company of Japan.

In some embodiments, the adhesive layer also comprises additives such as wetting agents, pigments, antioxidants, ultraviolet absorbers, is antistatic agents, lubricants, fillers, opacifying agents, anti-foam agents, and heat- and light-stabilizers, e.g., hindered amines. When present, the additives comprise in total less than 10 wt % of the adhesive layer.

In some embodiments, the adhesive has an inherent viscosity in a range of 0.3 dl/g or greater, or from 0.3-2.0 dl/g, or from 0.7-2.0 dl/g. In some embodiments, the adhesive has a glass transition temperature of −10° C. or less, or from −70 to −20° C., and a 180° peel adhesion test value in a range of 5-40 oz/in, or 7-25 oz/in, or 10-20 oz/in. In some embodiments, the adhesive layer has a 30 minute gap test value of 3 mm or less, or 2 mm or less, and a haze test value of less than 10%, or less than 5%, or less than 2%. In some embodiments, the adhesive layer is colorless as defined by the CIELAB color scale, with an L* value of 95 or more, and a* and b* values between −0.7 and +0.7.

In some embodiments, the molecular weight of the adhesive is 800,000-2,000,000. Although there are many factors that contribute to the properties of an adhesive, it is generally believed that tack and resistance to peel increase with increasing molecular weight until a maximum is reached. If the molecular weight is increased by too much, there can be a deterioration of desired properties because adhesives that contain higher molecular weight polymers tend to have more cohesive strength, but lower adhesive strength. For the present adhesive polymers this maximum is reached at a relatively low molecular weight, but may not be a discrete molecular weight maximum. One of ordinary skill can determine the limitations of molecular weight versus properties for the adhesives of the present invention.

In some embodiments, the adhesive layer comprises: an adhesive with an inherent viscosity in a range of 0.7-2.0 dl/g; 0.1-3.0 parts of a peroxide; and 15 to 50 parts of a tackifier compatible with the adhesive.

In other embodiments, the adhesive layer comprises 100 parts of an adhesive having an inherent viscosity in a range of 0.3 to 0.7 dl/g; 0.2 to 5.0 parts of a peroxide; and 5 to 40 parts of a tackifier compatible with the adhesive.

In further embodiments, the adhesive layer comprises 100 parts of is an adhesive having an inherent viscosity in a range of 1.5 to 2.0 dl/g; 0.2 to 0.8 parts of a peroxide; and 20 to 50 parts of a tackifier compatible with the adhesive.

In another embodiment, the adhesive layer comprises 100 parts of an adhesive having an inherent viscosity in a range of 0.5 to 1.0 dl/g; 0.4 to 1.0 parts of a peroxide; and 10 to 35 parts of a tackifier compatible with the adhesive.

### EXAMPLES

### General

The following materials are referred to in the Examples, and are identified here.

Dow Corning® 7358 (“DC7358”), polydimethylsiloxane resin (Dow Corning, Midland, Mich.).

Dow Corning® Q2-7735 (“DCQ27735”), polydimethylsiloxane resin (Dow Corning Co., Midland, Mich.).

### Examples 1-2

The adhesive formulations were prepared by mixing the polymers, additives, and solvent, in the ratios listed in Table 1.

TABLE 1

| | Resin | Peroxide | Solvent |
|---|---|---|---|
| Example | (parts by wt) | (parts by wt) | (parts by wt) |
| 1 | DC7358 | Benzoyl peroxide | Ethyl acetate |
| | (10) | (0.06) | (1.5) |
| 2 | DCQ27735 | Benzoyl peroxide | Ethyl acetate |
| | (10) | (0.06) | (1.5) |

The formulated adhesives were applied to fluorinated ethylene propylene (FEP) copolymer film by manual drawdown using a No. 4 Meyer rod, and then dried at 105° C. for 1 min. Dry coating thickness was 0.8-1.0 mil. A sample of ALDPET (PET film coated with aluminum oxide via atomic layer deposition) film was laminated using a Pressure Sensitive Tape Council roller at room temperature to the adhesive-coated FEP film.

The peel strength between the ALDPET and FEP layers of the as-made laminate was measured on an Instron® Universal Testing Instrument Model 1122 (Instron Worldwide, Norwood, Mass.), using 1″ strips cut from the laminated samples. The peel strength was measured using a 50 Kg loading in a 90° peel test. The free ends of ALDPET and FEP layers of the laminated sample were put into the clamps of the Instron is tester and pulled in opposite directions (at an angle of 90° from the sample) at a rate of 12 inches/min. Usually a large initial tension force is required to start the peel, and a constant steady-state force is needed to propagate the peel. Testing was stopped after the clamps had moved 3″ from each other relative to their starting position. This geometry is based on ASTM D903, a standard test method for Peel or Stripping Strength of Adhesive Bonds. Results of this test for Examples 1-2 are shown in Table 2.

A multi-layer lamination sample was made by laminating a second adhesive-coated FEP film to the unlaminated side of the ALDPET layer of the ALDPET/FEP laminate to make an FEP/ALDPET/FEP laminate.

A testing sample made in such manner was subjected to the humidity simulation test at 85% humidity and 85° C. for up to 2000 hours. The laminates did not undergo significant degradation. The peel strength between ALDPET and FEP layers after heat and humidity testing are shown in Table 2 for Examples 1-2.

A 7.5 cm×7.5 cm lamination sample was tested in the UV exposure simulation test for 1200 hours, during which time the laminate did not undergo significant degradation. In this test, an Atlas Weather-Ometer® Model Ci 65 (Atlas Electric Devices Company, Chicago, Ill.) was used, which utilized a water-cooled xenon arc lamp set at 0.55 watts/m², a borosilicate outer filter, and a quartz inner filter to provide a constant source of 340 nm light. The peel strength results between the ALDPET and PET layers after UV exposure for Examples 1-2 are given in Table 2. The environmental temperature of the UV chamber was 67° C.

TABLE 2

| | | After heat and | |
|---|---|---|---|
| Example | As-made laminates | humidity testing | After UV exposure |
| 1 | 2302 | 1930 | 489 |
| 2 | 1231 | 2928 | 606 |

The optical properties of the films were determined by Total Luminous Transmission (TLT), measured on an XL 211 Hazeguard™ or Hazeguard™ Plus system, available from BYK Gardner of Columbia, Md. using ASTM method D1003-92. Higher TLT value means less reflection and glare, with values of 94 being considered the minimum acceptable for good anti-reflective performance. The TLT before and after 2500 hours of 85° C. and 85% humidity test are given in Table 3.

TABLE 3

| Example | Initial TLT | TLT after 2500 h |
|---|---|---|
| 1 | 95.1 | 95.0 |
| 2 | 95.2 | 95.6 |

What is claimed is:

1. A laminate article comprising:
a) a first substrate layer comprising a fluorine-containing surface;
b) a second substrate layer; and
c) an adhesive layer in contact with both the fluorine-containing surface of the first substrate layer and the second substrate layer, wherein the adhesive layer comprises:
i) a polydimethylsiloxane resin; and
ii) a peroxide.

2. The laminate article of claim 1, wherein the first substrate layer comprises fluoropolymer films, fluoropolymer sheets or fluoropolymer-coated substrates.

3. The laminate article of claim 2, wherein the fluoropolymer is is selected from the group consisting of polytetrafluoroethylene, polyvinyl fluoride, polyvinylidene fluoride, fluorinated ethylene-propylene copolymer, and polyethylenetetrafluoroethylene.

4. The laminate article of claim 1, wherein the second substrate layer comprises foamed sheets, metal sheets, fabric, polymer films or polymer sheets.

5. The laminate article of claim 4, wherein the polymer is selected from the group consisting of polyolefins, polyamides, polyimides, and polyesters.

6. The laminate article of claim 4, wherein the second substrate layer is coated with a metal, a metal oxide or a metal nitride.

7. The laminate article of claim 1, wherein the peroxide is selected from the group consisting of benzoyl peroxide, t-butyl peroxybenzoate, and 2,4-dichlorobenzoyl peroxide.

8. The laminate of claim 1, wherein the adhesive layer further comprises additives selected from the group consisting of tackifiers, solvents, wetting agents, pigments, antioxidants, ultraviolet absorbers, antistatic agents, lubricants, fillers, opacifying agents, anti-foam agents, and heat- and light-stabilizers.
